(19) United States
(12) Patent Application Publication
(10) Pub. No.: US 2011/0301061 A1
(43) Pub. Date: Dec. 8, 2011

(54) HIGH THROUGHPUT EXPERIMENTATION METHODS FOR PHASE SEPARATION

(75) Inventors: Cato Russell McDaniel, The Woodlands, TX (US); David B. Engel, The Woodlands, TX (US); Alan E. Goliaszewski, Hockessin, DE (US)

(73) Assignee: GENERAL ELECTRIC COMPANY, Schenectady, NY (US)

(21) Appl. No.: 12/795,217

(22) Filed: Jun. 7, 2010

(51) Int. Cl. C40B 30/10; C40B 60/12

(52) U.S. Cl. 506/12; 506/39

(57) ABSTRACT

A process for testing the effectiveness of demulsifying additives on oil/water emulsions includes adding samples containing differing combinations of oil, water and demulsifier to a plurality of elongate reactor vials, wherein each the elongate reactor vial has a longitudinal axis extending from its bottom to its rim. The plurality of reactor vials are placed into a reaction block mounted on a platform of a shaker, wherein the reactor vials are received in stations of the reaction block in a vertical orientation such that the longitudinal axis of each reactor vial is perpendicular to the platform. The reaction block is pivoted the so that the longitudinal axis of each reactor vial is parallel with the platform in a horizontal orientation. The method further includes agitating the reactor vials with the shaker to simultaneously form an oil/water emulsion in each reactor vial while the reactor vials are in the horizontal orientation and then pivoting the reaction block to return the reactor vials to a vertical orientation. The demulsification of the oil/water emulsion in the plurality of reactor vials is observed with the reactor vials in the vertical orientation. In one embodiment, the method further includes using an imaging device to record the demulsification of the oil/water emulsion.

### BACKGROUND OF THE INVENTION

1. Field of the Invention

The present invention relates generally to testing of water-in-oil and oil-in-water emulsion breaker chemicals, and in particular, to testing methods using reactor blocks suitable for use in high-throughput testing programs in which chemical reactions are conducted simultaneously using small volumes of reaction materials to efficiently and economically screen multiple chemical materials.

2. Description of Related Art

Liquid hydrocarbon phase, such as crude oil, naturally contains a variety of contaminants that have detrimental effects on process equipment and in the operation of a refinery. These contaminants are broadly classified as salts, bottom sediment, water, solids, and metals. The types and amounts of these contaminants vary depending on the particular hydrocarbon phase. Additionally, native water present in the liquid hydrocarbon phase as droplets may be coated with naturally occurring surfactants such as asphaltenes, naphthenic acid salts, resins, or with solids including but not limited to iron oxide, silica, carbon, carbonates, or phosphates. Removing the water from the crude oil is essential at crude oil production facilities as it impacts the value of crude oil and its economic transportation. The presence of salts, especially chlorides of Group I and Group II elements of The Periodic Table of Elements causes corrosion of oil processing equipment. In order to mitigate the effects of corrosion, it is advantageous to reduce the salt concentration to the range of 1 to 5 ppm or less and water content to about 0.10 to 1 wt % by weight of the crude oil prior to transportation and processing of the oil.

A standard treatment for removing small particles of solids and bottom sediment, salts, water and metals is a phase separation operation commonly known as dewatering or desalting. A fresh water wash in the range of typically 4 to 15 vol % is injected into the crude oil. The crude oil and wash water are subjected to shear to thoroughly mix the water and the crude oil to form an emulsion and to transfer the contaminants from the crude oil into the fresh water. Frequently, a chemical emulsion breaker is also added to the emulsion, and often, the emulsion is subjected to an electrostatic field so that water droplets in the mixture of crude oil, wash water, and chemical emulsion breaker coalesce in the electrostatic field between electrodes. The coalesced water droplets settle below the oleaginous crude oil phase and are removed. The treated crude oil is removed from the upper part of the separator.

One problem encountered with dewatering and desalting is that some crude oils form an undesirable “rag” layer comprising a stable oil-water emulsion and solids at the water-oil phase boundary in the desalter vessel. The rag layer often remains in the vessel, but it may be removed for storage or for further processing. Rag layers at the water-oil phase boundary result in oil loss and reduced processing capacity. Heavy crude oils containing high concentrations of asphaltenes, resins, waxes, and napthenic acids exhibit a high propensity to form rag layers.

Additives may be added to improve coalescence and dehydration of the hydrocarbon phase, provide faster water separation, improve salt or solids extraction, and generate oil-free effluent water. These additives, also known as demulsifiers, are usually fed to the hydrocarbon phase to modify the oil/water interface. It is also possible to feed these materials to the wash water or to both the oil and water. These additives allow droplets of water to coalesce more readily and for the surfaces of solids to be water-wetted. The additives reduce the effective time required for good separation of oil, solids, and water.

Development of new chemical demulsifiers has typically been done using glass bottles or glass tubes in a process referred to as “bottle testing”. In the simplest embodiment, an oil sample and treatment chemicals are added to a bottle and shaken. The rate of demulsification (water removal) is then monitored as a function of time by observing the amount of “free” water that collects at the bottom of the bottle through visual inspection. This method has proven to be useful but is time consuming, and it often fails to consistently reproduce test parameters so that the effectiveness of different chemical demulsifiers can adequately be compared.

It is desired to improve high volume testing methods and equipment such that one may select the most efficacious chemicals to optimize the emulsion breaker process.

### SUMMARY OF THE INVENTION

In one aspect, the invention is directed to a process for testing the effectiveness of demulsifying additives on water-in-oil or oil-in-water emulsions. The process includes adding samples containing differing combinations of oil, water and demulsifier to a plurality of elongate reactor vials, wherein each the elongate reactor vial has a longitudinal axis extending from its bottom to its rim. The plurality of reactor vials are placed into a reaction block mounted on a platform of a shaker, wherein the reactor vials are received in stations of the reaction block in a vertical orientation such that the longitudinal axis of each reactor vial is perpendicular to the platform. The reaction block is pivoted the so that the longitudinal axis of each reactor vial is parallel with the platform in a horizontal orientation. The method further includes agitating the reactor vials with the shaker to simultaneously form an oil/water emulsion in each reactor vial while the reactor vials are in the horizontal orientation and then pivoting the reaction block to return the reactor vials to a vertical orientation. The demulsification of the oil/water emulsion in the plurality of reactor vials is observed with the reactor vials in the vertical orientation. In one embodiment, the method further includes using an imaging device to record the demulsification of the oil/water emulsion.

Another aspect of the invention is directed toward apparatus for testing the effectiveness of demulsifying additives on oil/water emulsions. The apparatus includes a plurality of elongate reactor vials for receiving samples containing differing combinations of oil, water and demulsifier to a plurality of reactor vials, wherein each elongate reactor vial has a longitudinal axis extending from its bottom to its rim. The apparatus also includes a reaction block configured to receive the plurality of reactor vials and a shaker having a platform for receiving the reaction block in a pivotable configuration. The reactor vials are received in stations of the reaction block in a vertical orientation such that the longitudinal axis of each reactor vial is perpendicular to the platform, and the reaction block is pivoted so that the longitudinal axis of each reactor vial is parallel with the platform in a horizontal orientation while agitating the reactor vials with the shaker to simultaneously form an oil/water emulsion in each reactor vial. The reaction block is then pivoted back so that demulsification of the oil/water emulsion is monitored with the reactor vials in a vertical orientation. In one embodiment, the apparatus also includes an imaging device used to record the demulsification of the oil/water emulsion.

The present invention and its advantages over the prior art will become apparent upon reading the following detailed description and the appended claims with reference to the accompanying drawings.

### BRIEF DESCRIPTION OF THE DRAWINGS

The above mentioned and other features of this invention will become more apparent and the invention itself will be better understood by reference to the following description of embodiments of the invention taken in conjunction with the accompanying drawings, wherein:

FIG. 1 is a perspective view of apparatus used for testing the effectiveness of demulsifying additives on oil/water emulsions;

FIG. 2 is a perspective view of the apparatus of FIG. 1 with a reaction block pivoting to a horizontal orientation; and

FIG. 3 is a perspective view of the apparatus of FIG. 1 with the reaction block pivoted to its horizontal orientation for agitation.

Corresponding reference characters indicate corresponding parts throughout the views of the drawings.

### DETAILED DESCRIPTION OF THE INVENTION

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications, and equivalents as will become apparent from consideration of the following detailed description.

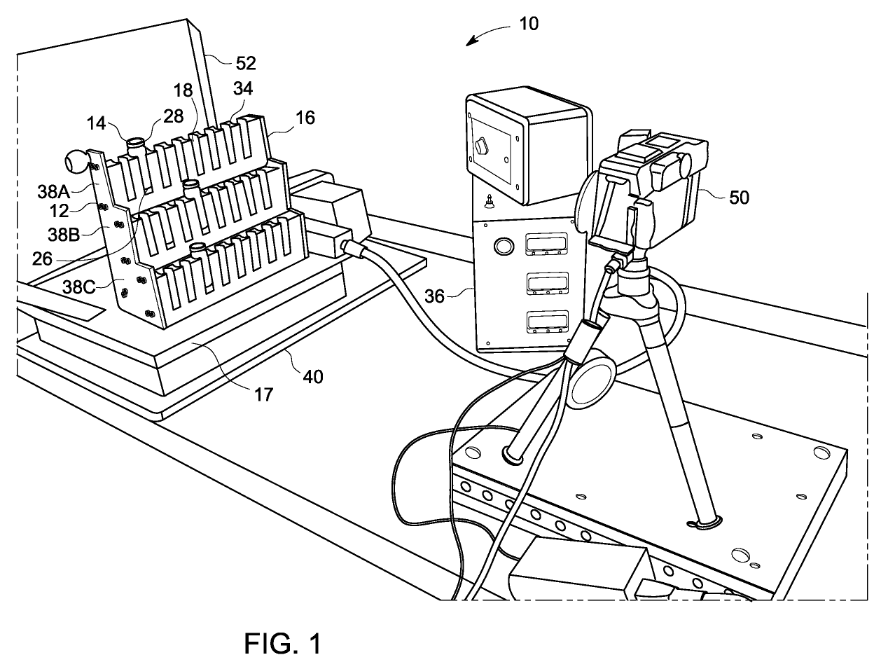

Referring now to FIG. 1, testing apparatus for simultaneously testing the effectiveness of multiple demulsifiers for breaking an oil/water emulsion is shown. The testing apparatus 10 contains a reaction block 12 configured to receive a plurality of reactor vials or tubes 14. The reaction block 12 is shown to incorporate a block body 16 that is mounted on a substantially planer platform 17 and configured to receive the reactor vials 14 in an array of stations 18. The reactor vials 14 are elongated tubular structures which are vertically disposed within the block body 16 when the reaction block 12 is in the orientation illustrated in FIG. 1. By vertically disposed, it is meant that the longitudinal axis of the reactor vial is substantially perpendicular to the plane of the platform 17. Each station 18 is desirably configured such that it securely retains an inserted reactor vial 14 using a suitable clip (not shown) or by frictional fit so as to discourage the reactor vial 14 from unintentionally falling out of the reactor block 12 during the testing process. In the illustrated embodiment, the stations 18 of the reactor block 12 are arrayed in a 24-station 18 array having a rectangular 3×8 format, or three rows 20 with eight stations 18 in each row. It should be apparent, however, that the invention might employ any of a variety of arrays other than a 3×8 format, and the array format need not even be rectangular. It is to be understood that each station 18 may contain a different crude oil and demulsifier composition to facilitate comparisons of different treatments. Therefore, testing on a specific crude oil composition can be conducted using several different emulsion breaker chemistries and concentrations to see which combination provides the most effective treatment. Alternately, a specific emulsion breaker may be tested on different crude oil compositions, or any combination crude oil and emulsion breakers may be tested simultaneously in the plurality of reactor vials 14 in the reaction block 12.

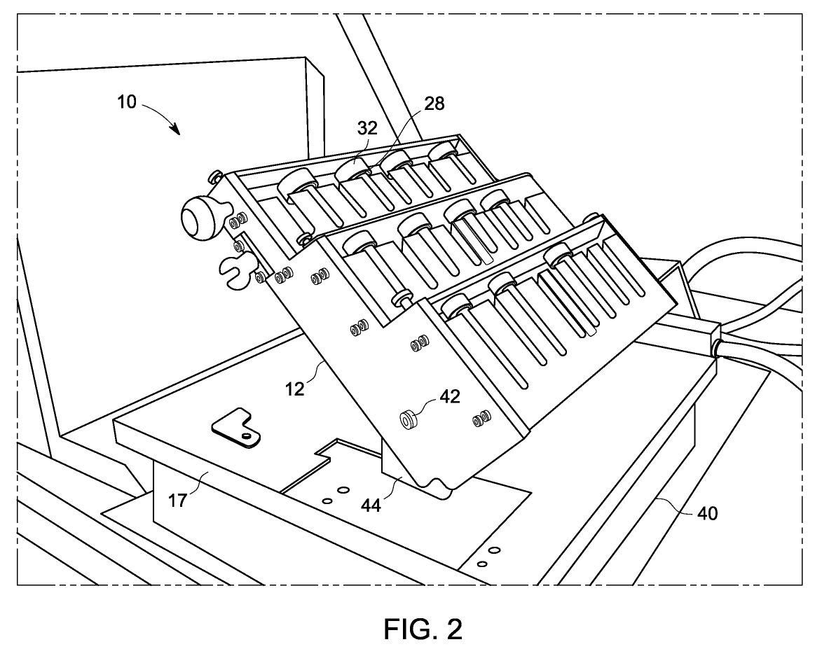

The reaction block 12 initially holds the reactor vials 14 in a stacked or vertical orientation. As best seen in FIG. 2, each row 20 of stations 18 in the reaction block 12 is offset from the other rows 20 to facilitate loading of reactor vials 14 in the reaction block 12. The reaction block 12 may be integrally formed by conventional injection molding, with the injection material being polypropylene plastic. However, it would be apparent that other molding and machining processes are also viable production processes. It would also be apparent to one with ordinary skill in the art that the reaction block 12 might be formed from other thermoplastics and from other sufficiently inert materials such as glasses, metals, and other types of resins as well. The block 12 might also be made from a combination of materials permanently or removably joined or fitted together.

Each of the reactor vials 14 includes an elongate tube bore 24, the length or height of the latter being determined from a vial bottom 26 up and to a vial rim 28. Each station 18 has a window 30 so that the tube bore 24 along its longitudinal axis is visible so that the oil/water separation in the reactor vial 14 may be monitored. Although in the reactor vials 14 are shown as having a cylindrical shape (i.e., a circular cross-section), it is understood that reactor vials having other shapes may be used. In one embodiment, the bottom 26 of the reactor vial 14 has a conical or V-shape portion to increase the precision of test results in this portion of the vial. In the illustrated embodiment, each reactor vial 14 has a volume of about 5 ml. It should be apparent, however, that the invention might employ vials 14 any of a variety of volumes, such as 100 ml, without departing from the scope of the invention. Desirably, each reactor vial 14 has a crimp cap 32 and Teflon® coated septa (not shown) rather than a screw cap, which may loosen during heating and shaking and leak. In one embodiment, an insulated electrode is placed outside the vials 14 to provide an electric field capable of voltages of 100 to 10,000 volts. Desirably, the electrode is configured to run perpendicular to the long axis of the vials 14.

The reaction block further comprises a heater 34 for controlling the temperature of the reactor vials 14 such that samples can be tested at near actual temperatures found in the field. The particular design for the heater 34 is not critical. In one embodiment, the heater 34 can use cartridge heating elements (e.g., resistive-heating element) in thermal communication with each station 18 of the reaction block 12. Alternatively, the heater 34 can use a hot gas or liquid to heat the reactor vials 14 or the reaction black 12 can be used in an enclosure defining a heated environment (e.g., oven). The heater desirably maintains temperature of the reactor vials between about 100 and 200° C., and more preferably between about 120-130° C., during the testing process.

One skilled in the art will understand that suitable temperature controllers 36 and sensors (not shown) are used with the heater 34 depending on the application. Desirably, surface mounted thermocouple, RTD or thermistors temperature sensors are mounted to the reaction block 12. In the illustrated embodiment, a digital temperature controller 36 is used to independently control the temperature of each row 20 in the reaction block such that there are three temperature zones 38A, 38B and 38C.

The reaction block 12 is mounted on the platform which is part of an agitation device or shaker 40. The agitation device 40 is used to emulsify the oil and water sample in each of the reactor vials 14. The particular design for the agitation device 40 is not critical and can be an orbital or linear shaker as known in the art. Subjecting the reaction block 12 to agitation provides a more consistent emulsion generation in all of the reactor vials 14 held in the reaction block 12 so that effective test comparisons can be made between each vial.

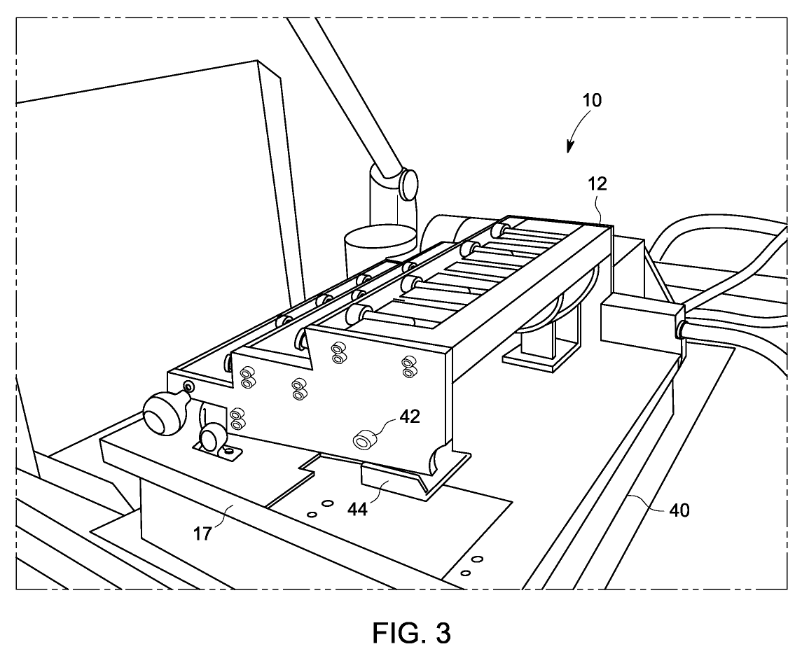

According to the invention, the reaction block 12 is mounted on the platform 17 such that it can be pivoted about 90 degrees from the generally vertical loading and observation array orientation shown in FIG. 1 to a generally horizontal orientation as shown in FIGS. 2 and 3 for shaking and emulsion forming. By a horizontal orientation, it is meant that the reactor block 12 is pivoted such that it holds the reactor vials 14 such that the longitudinal axes of the reactor vials 14 are substantially parallel with the plane of the platform 17. In one embodiment, the shaker 40 has a pivot member 42 to secure the reaction block 12 to the platform 17. This can be accomplished, for example, as best seen in FIG. 3 by providing the shaker 40 with a retaining means 44 such as an L-shaped flange fixed to or integral with platform 17 of the shaker 40. The L-shaped flange 44 retains a first end 46 of the reaction block 12 with the pivot member 42 so as to allow the reaction block to pivot with respect to the platform 17. However, one skilled in the art will understand that other means to pivotally mount the reaction block 12 to the platform 17 may be used using sound engineering judgment without departing from the scope of the invention.

The invention also encompasses the method of testing demulsifying additives for effective treatment of oil/water emulsions in a simultaneous and consistent manner using the testing apparatus. Reactor vials 14 containing the oil/water mixture and demulsifying agents are loaded into the reaction block 12 with the reaction block 12 in its vertical orientation. Alternately, the reactor vials 14 may be filled while in the reaction block 12. Desired temperature parameters are maintained with the heater 34. In order to simultaneously create the emulsions in the reactor vials 14, the reaction block 12 is pivoted to a substantially horizontal orientation, and the reaction block 12 is agitated with the shaker 40 while in the horizontal orientation. Without being limited to any specific reasoning, it has been found that better emulsions are formed when the reactor vials 14 are shaken in the horizontal orientation than if they were just shaken in the vertical orientation. After the emulsions are formed, the reaction block 12 is returned to the vertical orientation, and visual inspection of the demulsification in the reactor vials 14 is observed.

In one embodiment, an imaging device 50 is used to record the demulsification as seen in FIG. 1. The imaging device 50 may be a digital camera or other recording device used to record the separation of the oil and water in the reactor vials 14. The digital camera 50 can be operated manually or by using a controller (not shown) to record images at desired time intervals such that the operator need not be present during the entire time necessary to separate the emulsion. Accordingly, photography and image analysis may be used rather than visual inspection to collect the data. This allows all the reactor vials 14 to be assessed at the same time intervals which is desirable, since they all have the emulsion created at the same time. Desirably, a suitable backdrop 52 is place behind or on the back of the reaction block 12.

While the disclosure has been illustrated and described in typical embodiments, it is not intended to be limited to the details shown, since various modifications and substitutions can be made without departing in any way from the spirit of the present disclosure. As such, further modifications and equivalents of the disclosure herein disclosed may occur to persons skilled in the art using no more than routine experimentation, and all such modifications and equivalents are believed to be within the scope of the disclosure as defined by the following claims.

What is claimed is:

1. A process for testing the effectiveness of demulsifying additives on oil/water emulsions, the process comprising:
adding samples containing differing combinations of oil, water and demulsifier to a plurality of elongate reactor vials, wherein each said elongate reactor vial has a longitudinal axis extending from its bottom to its rim;
placing said plurality of reactor vials into a reaction block mounted on a platform of a shaker, wherein said reactor vials are received in stations of the reaction block in a vertical orientation such that the longitudinal axis of each reactor vial is perpendicular to the platform;
pivoting the reaction block so that the longitudinal axis of each reactor vial is parallel with the platform in a horizontal orientation;
agitating the reactor vials with the shaker to simultaneously form an oil/water emulsion in each reactor vial while said reactor vials are in the horizontal orientation;
pivoting the reaction block to return the reactor vials to a vertical orientation; and
observing the demulsification of the oil/water emulsion in the plurality of reactor vials.

2. The process of claim 1 further comprising using an imaging device to record the demulsification of the oil/water emulsion.

3. The process of claim 2 wherein the imaging device is a digital camera and a plurality of photographs are taken at different times to compare the effectiveness of demulsification between the plurality of vials.

4. The process of claim 1 wherein the reactor vials are placed in the reaction block in an array having a plurality of rows, wherein each row has a plurality of stations.

5. The process of claim 1 wherein samples containing less than about 5 ml of sample are added to the reactor vials.

6. The process of claim 1 further comprising heating the samples to at least 120° C.

7. The process of claim 1 wherein each sample contains a different demulsifier or different concentration of demulsifier.

8. Apparatus for testing the effectiveness of demulsifying additives on oil/water emulsions, the apparatus comprising:
a plurality of elongate reactor vials for receiving samples containing differing combinations of oil, water and demulsifier to a plurality of reactor vials, wherein each said elongate reactor vial has a longitudinal axis extending from its bottom to its rim;
a reaction block configured to receive the plurality of reactor vials; and
a shaker having a platform for receiving the reaction block in a pivotable configuration, wherein said reactor vials are received in stations of the reaction block in a vertical orientation such that the longitudinal axis of each reactor vial is perpendicular to the platform and said reaction block is pivoted so that the longitudinal axis of each reactor vial is parallel with the platform in a horizontal orientation while agitating the reactor vials with the shaker to simultaneously form an oil/water emulsion in each reactor vial and then pivoted back so that demulsification of the oil/water emulsion is monitored with the reactor vials in a vertical orientation.

9. The apparatus of claim 8 further comprising an imaging device used to record the demulsification of the oil/water emulsion.

10. The apparatus of claim 9 wherein the imaging device is a digital camera.

11. The apparatus claim 8 wherein the reaction block has a plurality of rows, wherein each row has a plurality of stations to receive a reactor vial.

12. The apparatus claim 8 wherein the reactor vials have a volume of about 5 ml.

13. The apparatus claim 12 wherein the reactor vials are closed using septa and metal caps crimped to the vials

14. The apparatus claim 8 further comprising a heating configured to heat the reactor vials to at least 120° C.

15. The apparatus in claim 8 further comprising an insulated electrode placed outside the vials to provide an electric field capable of voltages of 100 to 10,000 volts.

16. The process of claim 1 wherein samples are placed in reactor vials having a volume of about 100 ml or less.

17. The process of claim 1 wherein samples are placed in reactor vials having a volume of about 5 ml or less.
